(19) United States
(12) Patent Application Publication
(10) Pub. No.: US 2006/0217930 A1
(43) Pub. Date: Sep. 28, 2006

(54) Website-performance testing method

(75) Inventors: Zechary Chang, Taipei (TW); Sherry Xia, Beijing (CN); Cosmos Zhou, Beijing (CN); Wayne Zhou, Beijing (CN)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/087,861

(22) Filed: Mar. 24, 2005

(51) Int. Cl. G06F 11/30

(52) U.S. Cl. 702/186

(57) ABSTRACT

A website-performance testing method is applicable to test multiple websites at a time. It includes steps of: setting parameters and schedule of the testing task; starting tests according to the system clock; fetching website information from the task setting; connecting to the task website and performing the test; and recording and displaying the real-time test results. It tests multiple websites at a time with the same criteria. It meets the requirements of daily testing of website speed and providing information for the website maintenance personnel or decision-makers.

### FIELD OF THE INVENTION

The invention generally relates to a method for testing the performance of websites, and in particular relates to a method for automatically testing the performance of several websites at a time.

### BACKGROUND OF THE INVENTION

Along with the Internet vigorous development, more and more companies are providing their services through the network. We can see that no matter what a company is, it is essential now for the company to establish a website for her network service.

To evaluate the commercial value of a website, the most essential index is possibly the visitor rate. On the user site, the most concerned are the website content and the browsing and the downloading speed. The website content attracts the user. The browsing and downloading speed is the first impression of the user to grade the service quality of the website. These two aspects are the foundations of a website to survive and continue. Especially the speed factor, under the actual condition of serious homogeneity of website contents, the browsing and downloading speed directly influences the visitor rate.

Therefore, to evaluate a website application, testing the performance of similar websites with their browsing and downloading speeds is an effective technical method.

However, the evaluations now applicable are mostly done manually. Testing by feeling is less precise and low efficient. When testing multiple websites, manual-testing lacks of standard and uniform criteria, cannot provide real-time and useful information, and cannot generate any selectable or fixed report formats.

### SUMMARY OF THE INVENTION

The object of the invention is to solve the aforesaid problems and to provide an automatic website-performance testing method, based on standardized criteria to test multiple websites at a time, for comparing several parameters simultaneously and providing real-time reports in selectable formats.

A website-performance testing method according to the invention includes steps of: setting parameters and schedule of the testing task; starting tests according to the system clock; fetching website information from the task setting; connecting to the website and performing the test; and recording and displaying the test result.

The invention tests multiple websites at a time with the same criteria and displays the real-time test results. It meets the requirements of daily testing of website speed and providing information for the website maintenance personnel or decision-makers.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a flowchart of a website-performance testing method of the invention;

FIG. 2 is a main flowchart in an embodiment of the invention; and

FIG. 3 is a flowchart of performing preset tasks in the invention.

### DETAILED DESCRIPTION OF THE INVENTION

The invention provides an automatic website-performance testing method, based on standardized criteria to test multiple websites at a time, for comparing several parameters simultaneously and providing real-time reports in selectable formats.

A website-performance testing method according to the invention includes steps of: setting parameters and schedule of the testing task; starting tests according to the system clock; fetching website information from the task setting; connecting to the task website and performing the test; and recording and displaying the test results.

The invention tests multiple websites at a time with the same criteria and displays the real-time test results. It meets the requirements of daily testing of website speed and providing information for the website maintenance personnel or decision-makers.

The primary object of the invention is taken automatic testing of website speed. When turning on the computer, a testing program of the invention is loaded to the memory. It checks the system clock, starts a browser to check the preset website on preset time schedule, fetches system information and calculates the time interval from requesting to finishing the downloading of the webpage as an index of website speed. Other information can also be collected.

The invention includes several setting parameters. For example, setting multiple websites for obtaining a report of performance comparison of a target website to other websites. The comparison can be made in different manners, such as checking the speeds in different time periods of a website, or checking the speeds of different websites at the same time interval.

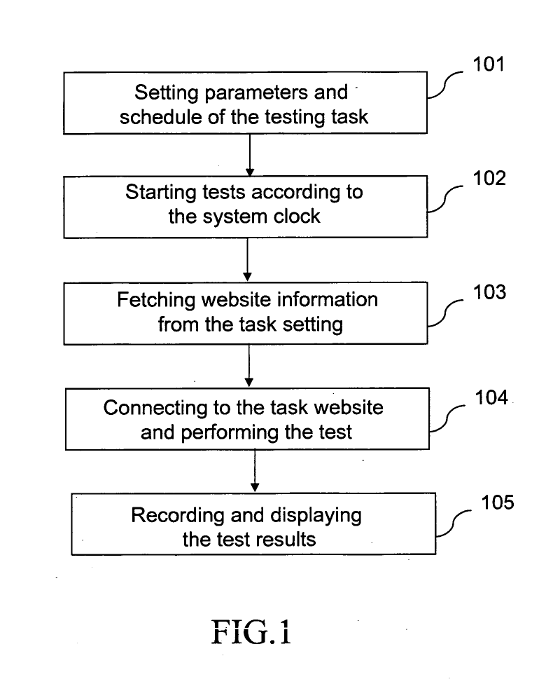

As shown in FIG. 1, a website-performance testing method according to the invention includes steps of: setting parameters and schedule of the testing task (step 101); starting tests according to the system clock (step 102); fetching website information from the task setting (step 103); connecting to the task website and performing the test (step 104); and recording and displaying the test results (step 105).

The parameters of setting include the number of websites to be tested, the website addresses, and the number of requesting persons and so on. For multiple-website testing, the website addresses can be preset, or randomly selected from a classified website databank according to the preset number of websites. The testing task can be a single task or multiple tasks. For example, a first task is described as “checking the homepage downloading speed of a specific website with 1000 visitors”; and a second task is described as “comparing the downloading speed of a specific website to some other similar websites or portal sites at the same time”.

The process in the invention can provide a group of requesting commends for testing the loading capacity of a specific website. The invention can provide test and comparison reports of visitor rate, downloading speed, loading capacity and so on.

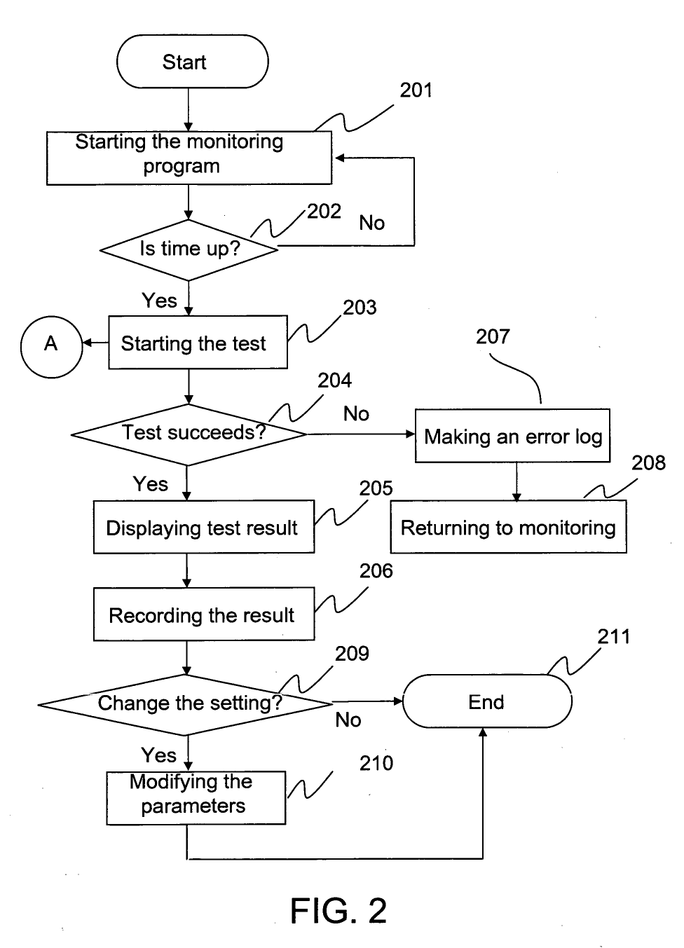

An embodiment of the invention is described below. The main flowchart of the embodiment is illustrated in FIG. 2. First, starting the monitoring program (step 201) for checking the system clock and comparing it with the preset testing schedule (step 202); staring the test if at the predetermined time, (step 203); judging if the test succeeds (step 204); making an error log (step 207) and continuing monitoring for the next test (step 208) when it fails, or displaying the test result (205) and making records (step 206) when the test succeeds; inquiring if the setting is to be changed (step 209); modifying the parameters when a change is required (step 210), or finishing the test when there is no need of change (step 211).

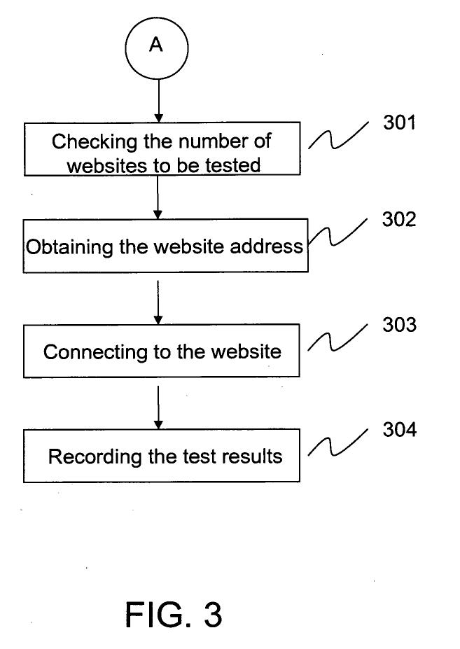

FIG. 3 shows a flowchart of performing preset tasks in the invention. First, checking the number of websites to be tested (step 301); obtaining the website addresses (step 302; the website addresses can be randomly selected from a classified website databank when not being specifically designated); connecting to the website and requesting downloading (with virtual requests N>1) (step 303), and recording the test results (step 304). Thus, the invention meets the requirements of daily testing of website speed and providing information for the website maintenance personnel or decision-makers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A website-performance testing method, based on standardized criteria to test multiple websites at a time, comprising steps of:
setting parameters and a schedule of a testing task;
checking a system clock and starting tests according to said schedule;
fetching a task website information from said testing task;
connecting to said task website and performing test; and
recording real-timely and displaying the test results.

2. The website-performance testing method of claim 1 wherein task parameters comprises number of websites to be tested, website addresses and number of requesting persons on said website.

3. The website-performance testing method of claim 1 wherein said testing task is a single task.

4. The website-performance testing method of claim 1 wherein said testing task comprises multiple tasks.

5. The website-performance testing method of claim 1 wherein said testing task comprises a group of requesting commends for testing the loading capacity of said website.

6. The website-performance testing method of claim 1 wherein said website is predetermined in said testing task.

7. The website-performance testing method of claim 1 wherein said website is randomly selected from a classified website databank.

8. The website-performance testing method of claim 1 further comprises a step of outputting test reports.

9. The website-performance testing method of claim 1 wherein said test reports comprises results of visitor rate, downloading speed and loading capacity.
